(19) United States
(12) Patent Application Publication
(10) Pub. No.: US 2006/0138715 A1
(43) Pub. Date: Jun. 29, 2006

(54) Doped ceramic materials and methods of forming the same

(76) Inventors: Leong Chew Lim, Singapore (SG); Ping Liu, Singapore (SG)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/291,271

(22) Filed: Dec. 1, 2005

Related U.S. Application Data
(60) Provisional application No. 60/632,244, filed on Dec. 1, 2004.

(51) Int. Cl. B32B 19/00; B32B 9/00; B28B 3/00

(52) U.S. Cl. 264/642; 428/701; 428/702; 428/699; 65/395

(57) ABSTRACT

A doped ceramic material comprising: a first layer comprising ceramic material and an amount of dopant, a second layer comprising the ceramic material, and a transitional layer connecting the first layer and the second layer. The transitional layer comprises the dopant in an amount which decreases in a direction from the first layer to the second layer. A method of forming the doped ceramic material is also disclosed.

### REFERENCE TO RELATED APPLICATION

This application claims the benefit of U.S. Provisional Application Ser. No. 60/632,244 filed Dec. 1, 2004.

### TECHNICAL FIELD

The present invention relates to doped ceramic materials and methods of forming the same. The present invention also relates to cutting tools formed from the doped ceramic materials.

### BACKGROUND

Ceramic materials for engineering applications generally possess properties such as high sintered densities, fine grain sizes, high hardness and reasonable fracture toughness. These properties enable ceramic materials to be employed in tools for cutting materials such as metals. one commonly used ceramic material for such an application is alumina.

In high speed cutting of carbon steel, a cutting speed as high as 1000 m/min may be desired. Most commercial alumina cutting tools are unsuitable for cutting at such a high speed due to accelerated flank wear of the alumina. The resistance of the alumina can be improved by increasing the hardness while decreasing the grain size of the ceramics.

One method of increasing the hardness of the alumina ceramic material is to dope the ceramic material with a dopant such as chromium oxide (Cr₂O₃). However, the addition of the dopant can decrease sinterability of the ceramic material. To overcome the problem of decreased sinterability, the doped ceramic material can be hot pressed or be sintered at a much higher temperature. Hot pressing can be an expensive process which may result in increased manufacturing costs. Sintering at a higher temperature can decrease the relative density and hardness of the ceramic material. Additionally, both of these processes can lead to abnormal grain growth of the ceramic material which results in a coarse grain structure.

There is therefore a need to provide a ceramic material that overcomes or at least ameliorates one or more of the disadvantages described above.

### SUMMARY OF INVENTION

According to a first aspect of the invention, there is provided a doped ceramic material comprising:

(a) a first layer comprising ceramic material and an amount of dopant,

(b) a second layer comprising the ceramic material, and

(c) a transitional layer connecting the first layer and the second layer, said transitional layer comprising the dopant in an amount which decreases in a direction from the first layer to the second layer.

According to a second aspect of the invention, there is provided a method of forming a doped ceramic material comprising the steps of:

(a) providing a high sinterability ceramic preform having a first layer, a second layer and a transitional layer connecting the first layer and the second layer;

(b) doping the first layer of the ceramic preform with an amount of dopant to thereby cause the amount of dopant in said transitional layer to decrease in a direction from the first layer to the second; and

(c) sintering the ceramic preform at a temperature for a period of time to form the doped ceramic material.

According to a third aspect of the invention, there is provided a Chromium Oxide (Cr₂O₃) doped alumina (Al₂O₃) material comprising:

(a) a first layer comprising Al₂O₃ material and an amount of Cr₂O₃,

(b) a second layer comprising the Al₂O₃ material, and

(c) a transitional layer connecting the first layer and the second layer, said transitional layer comprising Cr₂O₃ in an amount which decreases in a direction from the first layer to the second layer.

According to a fourth aspect of the invention, there is provided a method of forming chromium oxide (Cr₂O₃) doped alumina (Al₂O₃) material comprising the steps of:

(a) providing a high sinterability Al₂O₃ preform having a first layer, a second layer and a transitional layer connecting the first layer and the second layer;

(b) doping the first layer with an amount of Cr₂O₃ to thereby cause the amount of Cr₂O₃ in said transitional layer to decrease in a direction from the first layer to the second; and

(c) sintering the Al₂O₃ preform at a temperature for a period of time to form the Cr₂O₃ doped Al₂O₃ material.

According to a fifth aspect of the invention, there is provided a cutting tool formed from the doped ceramic material according to the first aspect.

According to a sixth aspect of the invention, there is provided a cutting tool formed from the Cr₂O₃ doped Al₂O₃ material according to the third aspect.

These and other aspects are discussed below.

### Definitions

The following words and terms used herein shall have the meaning indicated:

The term “relative density” as used herein refers to the ratio of actual density of a ceramic material or preform to the theoretical density of the ceramic material or preform.

The term “green body” as used herein relates to a moulded ceramic body that has not been pre-fired and sintered.

The term “preform” as used herein relates to a moulded ceramic body that has been pre-fired but has not undergone sintering.

The term “pre-firing” as used herein relates to heat treatment of the green body at a temperature and time period that do not result in densification of the green body. The green body, when pre-fired, forms a preform that is porous and can be used in subsequent processes such as shaping, doping and sintering. It will be understood that the term “pre-firing” does not exclude heat treatment that causes partial densification of the green body.

The term “sintering” as used herein relates to heat treatment of the preform at a temperature and time period to cause densification of the preform to form a sintered ceramic material having a relative density of at least 95%, preferably 96%, more preferably 97% and even more preferably 98%.

The term “compositional gradient” as used herein relates to a decreasing concentration profile of the dopant in the transitional layer of the ceramic material in a direction from the first layer to the second layer.

The term “abnormal grain” as used herein relates to a grain having a size that is about 5 to 10 times that of the average grain size of the doped ceramic material. In the context of alumina ceramic materials, an abnormal grain has a size that is greater than 5 μm .

The term “substantially no dopant” or “substantially no Cr₂O₃” as used herein does not exclude “completely no dopant” or “completely no Cr₂O₃”, e.g. a layer having “substantially no dopant” may have completely no dopant. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as all the individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### DETAILED DISCLOSURE OF EMBODIMENTS

Exemplary, non-limiting embodiments of doped ceramic materials, and in particular chromium oxide (Cr₂O₃) doped alumina (Al₂O₃) material, and methods of forming the same, will now be disclosed.

The doped ceramic material comprises:

(a) a first layer comprising ceramic material and an amount of dopant,

(b) a second layer comprising the ceramic material, and

(c) a transitional layer connecting the first layer and the second layer, said transitional layer comprising the dopant in an amount which decreases in a direction from the first layer to the second layer.

The relative density of the doped ceramic material can be at least about 97%.

The doped ceramic material can have an average grain size selected from the group consisting of: about 0.5 μm to about 5 μm; about 0.5 μm to about 4 μm; about 0.5 μm to about 3 μm; about 0.5 μm to about 2 μm; about 0.5 μm to about 1 μm; about 1 μm to about 5 μm; about 2 μm to about 5 μm; about 3 μm to about 5 μm; and about 4 μm to about 5 μm.

The surface hardness and fracture toughness of the doped ceramic material generally varies between different doped ceramic materials. The doped ceramic material of the disclosed embodiments, generally has a higher surface hardness and fracture toughness than the undoped ceramic and/or its corresponding uniformly doped ceramic material.

In one embodiment, the surface hardness of the doped ceramic material is at least about 17 GPa.

In one embodiment, the fracture toughness of the doped ceramic material is at least about 3.6 MPa(m^{1/2}).

The doped ceramic material, and in particular Cr₂O₃ doped Al₂O₃ material, may be used to manufacture cutting tools.

The method of forming doped ceramic material comprises the steps of:

(a) providing a high sinterability ceramic preform having a first layer, a second layer and a transitional layer connecting the first layer and the second layer;

(b) doping the first layer of the ceramic preform with an amount of dopant to thereby cause the amount of dopant in said transitional layer to decrease in a direction from the first layer to the second; and

(c) sintering the ceramic preform at a temperature for a period of time to form the doped ceramic material.

It will be understood that the three layers defined in step (a) are to provide antecedents for better defining subsequent steps (b) and (c) and should not be construed as limiting the ceramic preform to having three separate distinct layers.

In one embodiment, the first layer, the second layer and the transitional layer form an integral structure.

The sintering step (c) may comprise the step of:

(c1) sintering the ceramic preform at a temperature selected from the group consisting of: about 1200° C. to about 1600° C.; about 1200° C. to about 1500° C.; about 1200° C. to about 1400° C.; about 1200° C. to about 1300° C.; about 1300° C. to about 1600° C.; about 1400° C. to about 1600° C.; about 1500° C. to about 1600° C.; and about 1350° C. to about 1550° C.

The sintering step (c) may also comprise the step of:

(c2) sintering the ceramic preform for a period of time selected from the group consisting of: about 1 hour to about 24 hours; about 5 hours to about 24 hours; about 10 hours to about 24 hours; about 15 hours to about 24 hours; about 20 hours to about 24 hours; about 1 hour to about 20 hours; about 1 hour to about 15 hours; about 1 hour to about 10 hours; and about 1 hour to about 5 hours.

The sintering step (c) may be carried out under vacuum or under a suitable environment such as oxygen gas, nitrogen gas, argon gas or air. The sintering step (c) may comprise the step of:

(c3) sintering the ceramic preform in a vacuum.

The sintering step (c) may also comprise the step of:

(c4) sintering the ceramic preform in an environment of gases selected from the group consisting of: oxygen gas, nitrogen gas, argon gas, air and combinations thereof.

High Sinterability Ceramic Preform

The ceramic preform can be formed from at least two elements selected from the group consisting of: Group IIIA elements, Group IVA elements, Group IVB elements, Group VA elements and Group VIA elements of the periodic table of elements.

In one embodiment, the ceramic preform is selected from the group consisting of SiC, Si₃N₄, Al₂O₃, AlN, ZrO₂, SiO₂ and composites thereof. In another embodiment, the ceramic preform is Al₂O₃.

The ceramic preform may comprise additives to improve its physical properties. For example, Zirconia can be added to alumina to improve fracture toughness.

The providing step (a) in the method may comprise the steps of:

(a1) casting a suspension of ceramic powder into a mould to form a green body;

(a2) pre-firing the green body at a temperature for a period of time to form the high sinterability ceramic preform.

The ceramic powder may have an average particle size that is in a submicron range. In one embodiment, the casting step (a1) may comprise the step of:

(a3) selecting an average particle size of the ceramic powder from the group consisting of: about 0.05 μm to about 1 μm; about 0.05 μm to about 0.8 μm; about 0.05 μm to about 0.6 μm; about 0.05 μm to about 0.4 μm; about 0.05 μm to about 0.2 μm; about 0.05 μm to about 0.1 μm; about 0.1 μm to about 1 μm; about 0.2 μm to about 1 μm; about 0.4 μm to about 1 μm; about 0.6 μm to about 1 μm; about 0.8 μm to about 1 μm; and about 0.1 μm to about 0.2 μm . Advantageously, the submicron-grained ceramic preform can reduce or prevent occurrence of abnormal grain growth in the doped ceramic material of the disclosed embodiments which can lead to a course grain structure. Further, the submicron-grained ceramic preform can enable sintering in step (c) of the method to be carried out at a lower temperature as compared to uniformly doped ceramic materials.

The casting step (a1) may, for example, be carried out by slip casting, tape casting, gel casting, injection moulding or cold compaction.

The pre-firing step (a2) may comprise the step of:

(a4) pre-firing the green body at a temperature selected from the group consisting of: about 700° C. to about 1100° C.; about 800° C. to about 1100° C.; about 900° C. to about 1100° C.; about 1000° C. to about 1100° C.; about 700° C. to about 1000° C.; about 700° C. to about 900° C.; and about 700° C. to about 800° C.

The pre-firing step (a2) may comprise the step of:

(a5) pre-firing the green body for a time period selected from the group consisting of: about 1 hour to about 4 hours; about 2 hours to about 4 hours; about 3 hours to about 4 hours; about 1 hour to about 3 hours; and about 1 hour to about 2 hours.

The ceramic preform can be shaped into a desired dimension by polishing, sanding, cutting, grinding or other mechanical shaping processes prior to doping. Accordingly, the providing step (a) in the method may comprise the step of:

(a6) shaping the ceramic preform.

The ceramic preform resulting from steps (a1) to (a6) is of high sinterability and can have a relative density of at least about 58%.

Dopant

The dopant can be a metal oxide. The metal oxide can be a transition metal oxide. The transition metal oxide can be chromium oxide (Cr₂O₃).

In one embodiment, the amount of dopant in the first layer can be selected from the group consisting of: about 0.1 mol % to about 5 mol %; about 0.3 mol % to about 5 mol %; about 0.6 mol % to about 5 mol %; about 1 mol % to about 5 mol %; about 2 mol % to about 5 mol %; about 3 mol % to about 5 mol %; about 4 mol % to about 5 mol %; about 0.1 mol % to about 4 mol %; about 0.1 mol % to about 3 mol %; about 0.1 mol % to about 2 mol %; about 0.1 mol % to about 1 mol %; about 0.1 mol % to about 0.6 mol %; and about 0.1 mol % to about 0.3 mol %.

In one embodiment, the second layer has substantially no dopant.

The doping step (b) may comprise the step of:

(b1) immersing the ceramic preform into a solution having a concentration of the dopant for a period of time to dope the first layer with the amount of dopant and to cause infiltration of the dopant into the ceramic preform.

The immersing step (b1) may comprise the step of:

(b2) immersing the ceramic preform into a solution of dopant for a period of time selected from the group consisting of: about 15 minutes to about 5 hours; about 30 minutes to about 5 hours; about 1 hour to about 5 hours; about 2 hours to about 5 hours; about 3 hours to about 5 hours; about 4 hours to about 5 hours; about 15 minutes to about 4 hours; about 15 minutes to about 3 hours; about 15 minutes to about 2 hours; about 15 minutes to about 1 hour; and about 15 minutes to about 30 minutes.

The immersing step (b1) may comprise the step of:

(b3) immersing the ceramic preform in a saturated solution of the dopant.

The ceramic preform resulting from the doping step (b) may be dried prior to the sintering step (c). The conditions for drying may generally be about 50° C. to about 100° C. for about 1 hour to about 5 hours, or until the ceramic preform is dry.

The doping step (b) causes infiltration of the dopant into the ceramic preform to thereby result in the formation of a compositional gradient whereby the amount of the dopant decreases in the direction from the first layer to the second layer within the transition layer. The desired amounts of dopant in the first layer and the second layer may be achieved by controlling the immersion time of the ceramic preform in the dopant solution or by varying the concentration of the dopant solution.

Uniform doping of a ceramic preform generally decreases sinterability of the preform. However, by forming a compositional gradient in the transitional layer of the ceramic preform, the sinterability of the ceramic preform can be maintained.

The compositional gradient in the transitional layer can enable the ceramic preform that is doped with the dopant to sinter at a lower temperature as compared to the sintering temperature of ceramic preforms that are uniformly doped with the dopant.

The compositional gradient can also result in a doped ceramic material having a high sintered relative density, high surface hardness, fine grain structure and improved fracture toughness when compared to uniformly doped ceramic materials. The high surface hardness can be attributed to the presence of the dopant, in particular Cr₂O₃, in the first layer. The improved fracture toughness can be attributed to the controlled abnormal grain growth and a possible surface compressive stress state generated by the compositional gradient.

Chromium oxide (Cr₂O₃) Doped alumina (Al₂O₃) Material

The chromium oxide (Cr₂O₃) doped alumina (Al₂O₃) material comprises:

(a) a first layer comprising Al₂O₃ and an amount of Cr₂O₃,

(b) a second layer comprising Al₂O₃, and

(c) a transitional layer connecting the first layer and the second layer, said transitional layer comprising Cr₂O₃ in an amount which decreases in a direction from the first layer to the second layer.

In one embodiment, the amount of Cr₂O₃ in the first layer is selected from the group consisting of: about 0.1 mol % to about 5 mol %; about 0.3 mol % to about 5 mol %; about 0.6 mol % to about 5 mol %; about 1 mol % to about 5 mol %; about 2 mol % to about 5 mol %; about 3 mol % to about 5 mol %; about 4 mol % to about 5 mol %; about 0.1 mol % to about 4 mol %; about 0.1 mol % to about 3 mol %; about 0.1 mol % to about 2 mol %; about 0.1 mol % to about 1 mol %; about 0.1 mol % to about 0.6 mol %; and about 0.1 mol % to about 0.3 mol %.

In one embodiment, the second layer has substantially no Cr₂O₃.

The Cr₂O₃ doped Al₂O₃ material can have a sintered relative density of at least about 98%.

The average grain size of the Cr₂O₃ doped Al₂O₃ material can be selected from the group consisting of: about 0.5 μm to about 5 μm; about 0.5 μm to about 4 μm; about 0.5 μm to about 3 μm; about 0.5 μm to about 2 μm; about 0.5 μm to about 1 μm; about 1 μm to about 5 μm; about 2 μm to about 5 μm; about 3 μm to about 5 μm; and about 4 μm to about 5 μm.

The surface hardness of the Cr₂O₃ doped Al₂O₃ material can be at least about 17 GPa.

The Cr₂O₃ doped Al₂O₃ material can have a fracture toughness of at least about 3.6 MPa(m^{1/2}).

The method of forming chromium oxide (Cr₂O₃) doped alumina (Al₂O₃) material comprises the steps of:

(a) providing a high sinterability Al₂O₃ preform having a first layer, a second layer and a transitional layer connecting the first layer and the second layer;

(b) doping the first layer with an amount of Cr₂O₃ to thereby cause the amount of Cr₂O₃ in said transitional layer to decrease in a direction from the first layer to the second; and

(c) sintering the Al₂O₃ preform at a temperature for a period of time to form the Cr₂O₃ doped Al₂O₃ material.

It will be understood that the three layers defined in step (a) are to provide antecedents for better defining subsequent steps (b) and (c) and should not be construed as limiting the starting ceramic preform to having three separate distinct layers.

In one embodiment, the first layer, the second layer and the transitional layer form an integral structure.

The providing step (a) may comprise the steps of:

(a1) casting a suspension of Al₂O₃ powder into a mould to form a green body;

(a2) pre-firing the green body at a temperature for a period of time to form the high sinterability Al₂O₃ preform.

The casting step (al) may comprise the step of:

(a3) selecting an average particle size of the Al₂O₃ powder from the group consisting of: about 0.05 μm to about 1 μm; about 0.05 μm to about 0.8 μm; about 0.05 μm to about 0.6 μm; about 0.05 μm to about 0.4 μm; about 0.05 μm to about 0.2 μm; about 0.05 μm to about 0.1 μm; about 0.1 μm to about 1 μm; about 0.2 μm to about 1 μm; about 0.4 μm to about 1 μm; about 0.6 μm to about 1 μm; about 0.8 μm to about 1 μm; and about 0.1 μm to about 0.2 μm.

The pre-firing step (a2) may comprise the step of:

(a4) pre-firing the green body at a temperature selected from the group consisting of: about 700° C. to about 1100° C.; about 800° C. to about 1100° C.; about 900° C. to about 1100° C.; about 1000° C. to about 1100° C.; about 700° C. to about 1000° C.; about 700° C. to about 900° C.; and about 700° C. to about 800° C.

The pre-firing step (a2) may comprise the step of:

(a5) pre-firing the green body for a time period selected from the group consisting of: about 1 hour to about 4 hours; about 2 hours to about 4 hours; about 3 hours to about 4 hours; about 1 hour to about 3 hours; and about 1 hour to about 2 hours.

The doping step (b) may comprise the step of:

(b1) selecting the amount of Cr₂O₃ in the first layer from the group consisting of: about 0.1 mol % to about 5 mol %; about 0.3 mol % to about 5 mol %; about 0.6 mol % to about 5 mol %; about 1 mol % to about 5 mol %; about 2 mol % to about 5 mol %; about 3 mol % to about 5 mol %; about 4 mol % to about 5 mol %; about 0.1 mol % to about 4 mol %; about 0.1 mol % to about 3 mol %; about 0.1 mol % to about 2 mol %; about 0.1 mol % to about 1 mol %; about 0.1 mol % to about 0.6 mol %; and about 0.1 mol % to about 0.3 mol %.

The doping step (b) may comprise the step of:

(b2) selecting the amount of Cr₂O₃ in the second layer as about 0 mol %.

The doping step (b) may comprise the steps of:

(b3) immersing the Al₂O₃ preform into a solution having a concentration of chromic acid for a period of time to cause infiltration of chromic acid into the Al₂O₃ preform; and

(b4) heating the Al₂O₃ preform at a temperature for a period of time to convert the chromic acid to Cr₂O₃.

The immersing step (b3) may comprise the step of:

(b5) immersing the Al₂O₃ preform into the solution of chromium acid for a period of time selected from the group consisting of: about 15 minutes to about 5 hours; about 30 minutes to about 5 hours; about 1 hour to about 5 hours; about 2 hours to about 5 hours; about 3 hours to about 5 hours; about 4 hours to about 5 hours; about 15 minutes to about 4 hours; about 15 minutes to about 3 hours; about 15 minutes to about 2 hours; about 15 minutes to about 1 hour; and about 15 minutes to about 30 minutes.

The immersing step (b3) may comprise the step of:

(b6) immersing the Al₂O₃ preform in a saturated solution of chromium acid.

The heating step (b4) may comprise the step of:

(b7) heating the Al₂O₃ preform for a period of time selected from the group consisting of: about 15 minutes to about 10 hours; about 15 minutes to about 8 hours; about 15 minutes to about 6 hours; about 15 minutes to 15 about 4 hours; about 15 minutes to about 2 hours; about 15 minutes to about 1 hour; about 1 hour to about 10 hours; about 2 hours to about 10 hours; about 4 hours to about 10 hours; about 6 hours to about 10 hours; and about 8 hours to about 10 hours.

The heating step (b4) may comprise the step of:

(b8) heating the Al₂O₃ preform at a temperature selected from the group consisting of: about 400° C. to about 800° C.; about 500° C. to about 800° C.; about 600° C. to about 800° C.; about 700° C. to about 800° C.; about 400° C. to about 700° C.; about 400° C. to about 600° C.; about 400° C. to about 500° C.; and about 450° C. to about 750° C.

The sintering step (c) may comprise the step of:

(c1) sintering the Al₂O₃ preform at a temperature selected from the group consisting of: about 1200° C. to about 1600° C.; about 1200° C. to about 1500° C.; about 1200° C. to about 1400° C.; about 1200° C. to about 1300° C.; about 1300° C. to about 1600° C.; about 1400° C. to about 1600° C.; about 1500° C. to about 1600° C.; and about 1350° C. to about 1550° C.

The sintering step (c) may comprise the step of:

(c2) sintering the Al₂O₃ preform for a period of time selected from the group consisting of: about 1 hour to about 24 hours; about 5 hours to about 24 hours; about 10 hours to about 24 hours; about 15 hours to about 24 hours; about 20 hours to about 24 hours; about 1 hour to about 20 hours; about 1 hour to about 15 hours; about 1 hour to about 10 hours; and about 1 hour to about 5 hours.

The sintering step (c) may comprise the step of:

(c3) sintering the Al₂O₃ preform in a vacuum.

The sintering step (c) may comprise the step of:

(c4) sintering the ceramic preform in an environment of gases selected from the group consisting of: oxygen gas, nitrogen gas, argon gas, air and combinations thereof.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 shows Steps 1 to 3 of a method of forming doped ceramic material in accordance with a disclosed embodiment;

FIG. 2 shows a mid-plane section of a Cr₂O₃ doped Al₂O₃ material produced in accordance with a disclosed embodiment;

FIG. 3 shows a scanning electron microscope (SEM) micrograph of 4,000 times magnification of a surface of a ceramic material doped with 2.0 mol % Cr₂O₃ in the first layer in accordance with a disclosed embodiment;

FIG. 4 shows a graph of average grain size of Cr₂O₃ doped Al₂O₃ material as a function of amount of Cr₂O₃ in the first layer;

FIG. 5(a) shows a graph of surface hardness of Cr₂O₃ doped Al₂O₃ material at room temperature as a function of amount of Cr₂O₃ in the first layer;

FIG. 5(b) shows a graph of fracture toughness of Cr₂O₃ doped Al₂O₃ material as a function of amount of Cr₂O₃ in the first layer; and

FIG. 6 illustrates flank wear behaviour of different alumina cutting tool inserts, including Cr₂O₃ doped Al₂O₃ material in accordance with a disclosed embodiment, when machining medium-carbon steel at 1000 m/min without a coolant.

### DETAILED DISCLOSURE OF THE PREFERRED EMBODIMENT

Non-limiting examples of the invention will be further described in greater detail by reference to specific Examples, which should not be construed as in any way limiting the scope of the invention.

### EXAMPLE 1

### Method of Forming Cr₂O₃ doped Al₂O₃ material

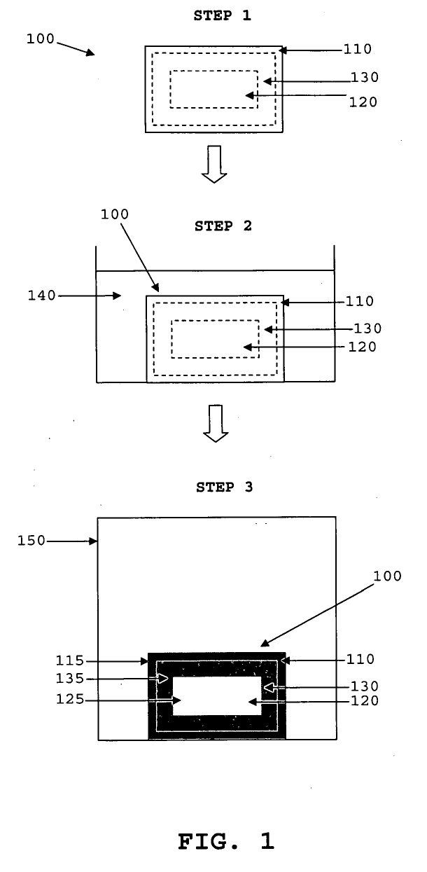

FIG. 1 shows the method steps of forming Cr₂O₃ doped Al₂O₃ material.

In Step 1, a high sinterability Al₂O₃ (alumina) preform 100 having a first layer 110, a second layer 120 and a transitional layer 130 connecting the first layer 110 and the second layer 120 was provided. The first layer 110, the second layer 120 and the transitional layer 130 form an integral structure and do not exist as distinct separate layers. The high sinterability Al₂O₃ preform 100 was provided by slip casting a colloidal suspension of Al₂O₃ powder (average particle size 0.18 μm) into a mould to form a green body, and pre-firing the green body at 850° C. for 1 hour to form the high sinterability Al₂O₃ preform. The Al₂O₃ preform has a relative density of 64% and is sanded to rectangular-shaped preforms measuring 17 mm×17 mm×6 mm in dimension.

In Step 2, the Al₂O₃ preform was immersed in a saturated solution chromic acid 140 for 1 hour to attain a concentration of 2.0 mol % chromic acid in the first layer 110 of the Al₂O₃ preform 100. The second layer of the Al₂O₃ preform has no chromic acid. The Al₂O₃ preform 100 was removed from the chromic acid solution 140 and dried at 80° C. for 1 hour. The Al₂O₃ preform 100 was subsequently heated at 650° C. for 1 hour to convert the chromic acid to Cr₂O₃.

In Step 3, the Al₂O₃ preform 100 was sintered under a vacuum in an oven 150 at 1450° C. for 3 hours to form the Cr₂O₃ doped Al₂O₃ material. The sintered Cr₂O₃ doped Al₂O₃ material was then removed from the oven. The final dimensions of the sintered Cr₂O₃ doped Al₂O₃ material was 15 mm×15 mm×5 mm.

The concentrations of chromic acid and Cr₂O₃ in the first layer 110 and the second layer 120 were determined by X-ray diffraction.

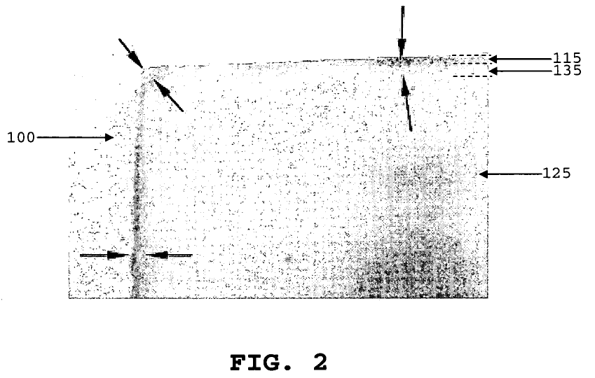

FIG. 2 shows a mid-plane view of the Cr₂O₃ doped Al₂O₃ material 100 formed from the above steps. The first layer 110 had the highest concentration of Cr₂O₃ (as shown by region 115), the second layer 120 had the lowest concentration of Cr₂O₃ (as shown by region 125) and the transitional layer 130 had a gradual decrease in concentration of Cr₂O₃ in the direction from the first layer to the second layer (as shown by region 135). The darker coloured regions represent a higher concentration of Cr₂O₃ while the lighter coloured regions represent a lower concentration of Cr₂O₃.

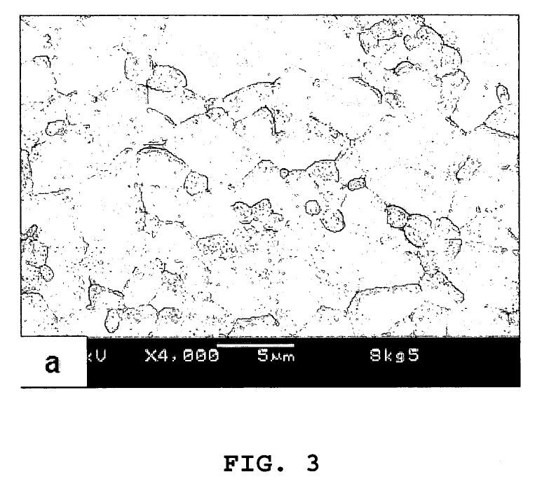

FIG. 3 shows a scanning electron microscope (SEM) micrograph of 4,000 times magnification of the Cr₂O₃ doped Al₂O₃ material formed from the above steps. The average grain size of the Cr₂O₃ doped Al₂O₃ material 100 was observed to be less than 5.0 μm. The resultant Cr₂O₃ doped Al₂O₃ material was more than 97% in relative density.

### EXAMPLE 2

### Comparison of Cr₂O₃ doped Al₂O₃ Materials Having Cr₂O₃ Concentrations of 0.0, 0.6, 1, 2 and 3.5 mol % in the First Layer

The method in Example 1 was repeated to form Cr₂O₃ doped Al₂O₃ materials having Cr₂O₃ concentrations of 0.6, 1, 2 and 3.5 mol % in the first layer.

Undoped Al₂O₃ material was provided by slip casting a colloidal suspension of Al₂O₃ powder (average particle size 0.18 μm into a mould to form a green body, and pre-firing the green body at 850° C. for 1 hour to form the Al₂O₃ preform. The Al₂O₃ preform is subsequently sintered under vacuum at a temperature of 1450° C. for 3 hours to form the undoped Al₂O₃ material.

Table 1 below tabulates the values of relative density, grain size, hardness and fracture toughness of the Cr₂O₃ doped Al₂O₃ material at Cr₂O₃ concentrations of 0.0, 0.6, 1, 2 and 3.5 mol % in the first layer.

TABLE 1

| Cr₂O₃ | | | | |
|---|---|---|---|---|
| content in | | | | Fracture |
| first layer | Relative | Grain Size | Hardness | Toughness |
| (mol %) | Density | (μm) | (GPa) | (M Pa m^{1/2}) |
| 0.0 | >99.5% | 4.6 ± 1.4 | 17.5 | 3.6 |
| 0.6 | >99.5% | 4.3 ± 1.5 | 18.2 | 3.8 |
| 1.0 | >99.5% | 4.5 ± 1.5 | 18.7 | 4.2 |
| 2.0 | >99.5% | 3.7 ± 0.9 | 20.1 | 3.7 |
| 3.5 | >99.5% | 3.8 ± 0.9 | 21.5 | 3.6 |

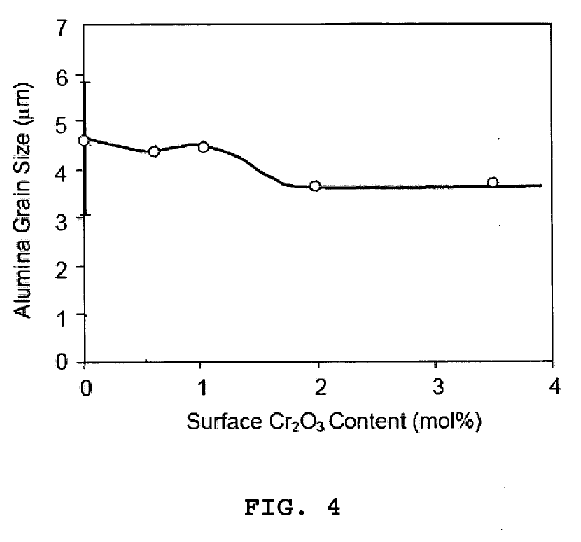

FIG. 4 shows a graph of average grain sizes of the Cr₂O₃ doped Al₂O₃ material as a function of Cr₂O₃ concentrations in the first layer. The values from Table 1 were used to generate the graph in FIG. 4. It was observed that none of the Cr₂O₃ doped Al₂O₃ materials exhibited an average grain size that is larger than about 5.0 μm, and that the average grain size decreases as the Cr₂O₃ concentrations in the first layer increases. Further, the Cr₂O₃ doped Al₂O₃ materials showed finer grain sizes as compared to undoped Al₂O₃ materials. The average grain size was measured from SEM micrographs taken from the surfaces of the Cr₂O₃ doped Al₂O₃ materials.

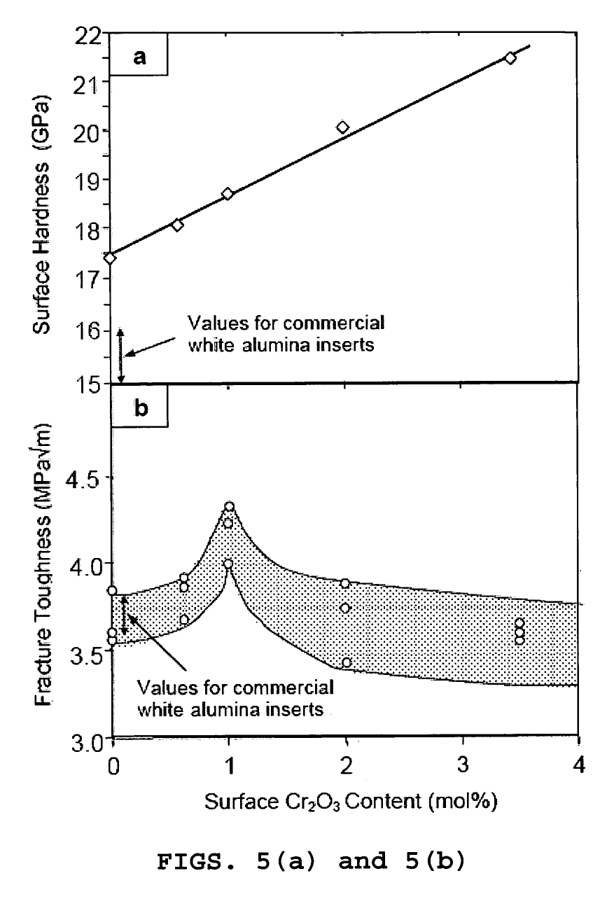

FIGS. 5(a) and 5(b) show, respectively, the graphs of surface hardness and fracture toughness of the Cr₂O₃ doped Al₂O₃ material as a function of Cr₂O₃ content in the first layer. The values from Table 1 were used to generate the graphs in FIGS. 5(a) and 5(b). The hardness and fracture toughness values of commercial white alumina material [Al₂O₃ with 3-5 vol % ZrO₂] are also shown in the graphs.

The Cr₂O₃ doped Al₂O₃ materials prepared in this Example exhibited higher surface hardness (17.5 to 21.5 GPa) as compared to that of commercial white alumina (15 to 16 GPa). Further, it was observed that the surface hardness of the Cr₂O₃ doped Al₂O₃ materials increases as the Cr₂O₃ content in the first layer increases.

There were three readings of fracture toughness [represented by 3 dots in the graph of FIG. 5(b)] taken at each concentration of Cr₂O₃. The fracture toughness can be measured by means of micro-indentation. Generally, it was observed that the fracture toughness of the Cr₂O₃ doped Al₂O₃ materials prepared in this Example are at least the same or higher than commercial white alumina. Further, it was observed that the optimally doped Al₂O₃ materials, i.e., doped to about 1.0 mol % Cr₂O₃ in the first layer, exhibited significantly higher fracture toughness as compared to undoped Al₂O₃. Additionally, the fracture toughness increases as the Cr₂O₃ concentration increases in the first layer.

Referring to Table 1 and FIGS. 5(a) and 5(b), it was be observed that, by increasing the amount of Cr₂O₃ in the first layer to about 1.0 mol %, both the surface hardness and fracture toughness of the Cr₂O₃ doped Al₂O₃ material can be increased simultaneously.

It was also observed that with a further increase in Cr₂O₃ content in the first layer, although the surface hardness of the doped alumina increases, the fracture toughness decreases to that of undoped alumina.

### EXAMPLE 3

### Tool Life of Cutting Tool Inserts Formed from Cr₂O₃ doped Al₂O₃ Material and Commercial White Alumina material [Al₂O₃ with 3-5 vol % ZrO₂]

A cutting tool insert formed from Cr₂O₃ doped Al₂O₃ material with a Cr₂O₃ content of 2.0 mol % in the first layer was produced in accordance with the method of Example 1 (referred to as Type C insert).

Two commercial white alumina [Al₂O₃ with 3-5 vol % ZrO₂] cutting tool inserts (referred to as Types S and K), were also provided for comparison purposes.

The inserts C, S and K were used to cut medium-carbon steel at high cutting speeds of 1000 m/min without a coolant.

The average grain sizes, room temperature properties and tool life of the three inserts are listed in Table 2 below.

| Cutting | | | Hard- | Fracture | Tool |
|---|---|---|---|---|---|
| Tool | | Grain | ness | Toughness | Life |
| Inserts | Composition | Size (μm) | (GPa) | (M Pa m^{1/2}) | (minutes) |
| C | Al₂O₃ | 3.7 ± 0.9 | 20.1 | 3.7 | 6.5 |
| | (2 mol % Cr₂O₃) | | | | |
| S | Al₂O₃ with | 2.3 ± 1.1 | 16.0 | 2.6 | 4.0 |
| | (3-5 vol % ZrO₃) | | | | |
| K | Al₂O₃ with | 2.1 ± 0.8 | 15.4 | 3.8 | 3.0 |
| | (3-5 vol % ZrO₃) | | | | |

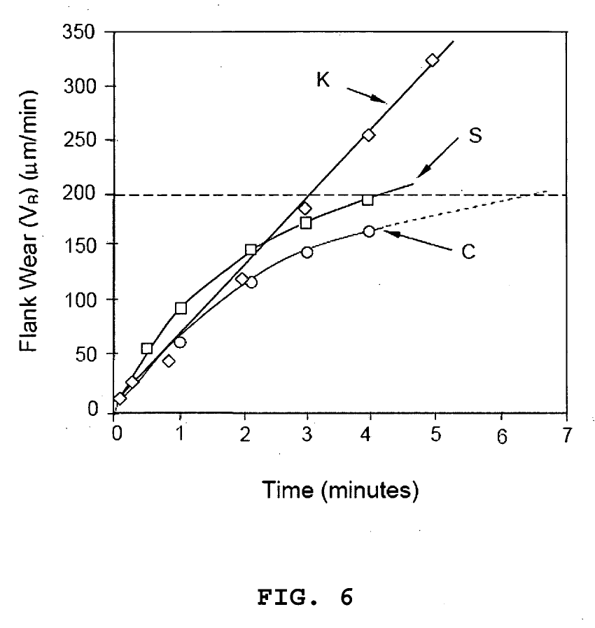

Turning test was carried out to assess the flank wear and the tool life of the three inserts. An Okuma (Type: LH35-H) computer-numerical-controlled (CNC) lathe machine was used to measure flank wear and the tool life of the three inserts. The cutting geometry was set at an inclination angle of −6°, rake angle of −6°, entering angle of 75°, and clearance angle of 6°. The feed rate and depth of cut were 0.25 mm/rev and 1.5 mm, respectively. FIG. 6 shows a graph of flank wear as a function of time. The tool life for each insert, which is the time (in minutes) taken to achieve a certain flank wear (μm/minute) is provided in the last column of Table 2.

It was observed from FIG. 6 and Table 2 that the Type C cutting tool insert provides superior flank wear resistance and considerably longer tool life.

It was observed that the performance of the Type C cutting tool insert may be further improved by decreasing its grain size (via sintering at a lower temperature) and/or by increasing its surface hardness (via a higher amount of Cr₂O₃ doping). Referring to FIG. 5(a), the surface hardness can be increased to beyond 22 GPa if the content of Cr₂O₃ in the first layer be increased to 4.0 mol % or higher.

### Applications

It will be appreciated that the disclosed doped ceramic materials and methods of forming the same are not limited to alumina material and chromium oxide dopant, and can be extended to other types of ceramic materials and dopants.

It will be appreciated that the doped ceramic material of the disclosed embodiments can have a relative density of at least 97% which is generally higher than that of undoped and uniformly doped ceramic materials of comparable relative density.

It will be appreciated that the doped ceramic material of the disclosed embodiments can have an average grain size selected from the group consisting of: about 0.5 μm to about 5 μm; about 0.5 μm to about 4 μm; about 0.5 μm to about 3 μm; about 0.5 μm to about 2 μm; about 0.5 μm to about 1 μm; about 1 μm to about 5 μm; about 2 μm to about 5 μm; about 3 μm to about 5 μm; and about 4 μm to about 5 μm, which is generally finer than that of undoped and uniformly doped ceramic materials of comparable relative density.

It will be appreciated that the doped ceramic material of the disclosed embodiments can have a surface hardness of at least 17 GPa, which is generally higher than that of undoped and uniformly doped ceramic materials of comparable relative density.

It will be appreciated that the doped ceramic material of the disclosed embodiments can have a fracture toughness of at least 3.6 MPa(m^{1/2}), which is generally higher than that of undoped and uniformly doped ceramic materials of comparable relative density.

It will be appreciated that the doped ceramic material of the disclosed embodiments can be sintered at a temperature that is generally lower than that of uniformly doped ceramic materials. This can be attributed to the high sinterability of the second layer.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A doped ceramic material comprising:
(a) a first layer comprising ceramic material and an amount of dopant,
(b) a second layer comprising the ceramic material, and
(c) a transitional layer connecting the first layer and the second layer, said transitional layer comprising the dopant in an amount which decreases in a direction from the first layer to the second layer.

2. A doped ceramic material according to claim 1, wherein the ceramic material is formed from at least two elements selected from the group consisting of: Group IIIA elements, Group IVA elements, Group IVB elements, Group VA elements and Group VIA elements of the periodic table of elements.

3. A doped ceramic material according to claim 2, wherein the ceramic material is selected from the group consisting of SiC, Si₃N₄, Al₂O₃, AlN, ZrO₂, SiO₂ and composites thereof.

4. A doped ceramic material according to claim 3, wherein the ceramic material is Al₂O₃.

5. A doped ceramic material according to claim 1, wherein the dopant is a metal oxide.

6. A doped ceramic material according to claim 5, wherein the metal oxide is a transition metal oxide.

7. A doped ceramic material according to claim 6, wherein the transition metal oxide is chromium oxide (Cr₂O₃).

8. A doped ceramic material according to claim 1, wherein the amount of dopant in the first layer is selected from the group consisting of: about 0.1 mol % to about 5 mol %; about 0.3 mol % to about 5 mol %; about 0.6 mol % to about 5 mol %; about 1 mol % to about 5 mol %; about 2 mol % to about 5 mol %; about 3 mol % to about 5 mol %; about 4 mol % to about 5 mol %; about 0.1 mol % to about 4 mol %; about 0.1 mol % to about 3 mol %; about 0.1 mol % to about 2 mol %; about 0.1 mol % to about 1 mol %; about 0.1 mol % to about 0.6 mol %; and about 0.1 mol % to about 0.3 mol %.

9. A doped ceramic material according to claim 1, wherein the second layer has substantially no dopant.

10. A doped ceramic material according to claim 1, wherein the doped ceramic material has a sintered relative density of at least about 97%.

11. A doped ceramic material according to claim 1, wherein the doped ceramic material has an average grain size selected from the group consisting of: about 0.5 μm to about 5 μm; about 0.5 μm to about 4 μm; about 0.5 μm to about 3 μm; about 0.5 μm to about 2 μm; about 0.5 μm to about 1 μm; about 1 μm to about 5 μm; about 2 μm to about 5 μm; about 3 μm to about 5 μm; and about 4 μm to about 5 μm.

12. A doped ceramic material according to claim 1, wherein the doped ceramic material has a surface hardness of at least about 17 GPa.

13. A doped ceramic material according to claim 1, wherein the doped ceramic material has a fracture toughness of at least about 3.6 MPa(m^{1/2}).

14. A method of forming a doped ceramic material comprising the steps of:
(a) providing a high sinterability ceramic preform having a first layer, a second layer and a transitional layer connecting the first layer and the second layer;
(b) doping the first layer of the ceramic preform with an amount of dopant to thereby cause the amount of dopant in said transitional layer to decrease in a direction from the first layer to the second; and
(c) sintering the ceramic preform at a temperature for a period of time to form the doped ceramic material.

15. A method of forming a doped ceramic material according to claim 14, wherein the first layer, the second layer and the transitional layer form an integral structure.

16. A method of forming a doped ceramic material according to claim 14, wherein the providing step (a) comprises the steps of:
(a1) casting a suspension of ceramic powder into a mould to form a green body;
(a2) pre-firing the green body at a temperature for a period of time to form the high sinterability ceramic preform.

17. A method of forming a doped ceramic material according to claim 16, wherein the casting step (al) comprises the step of:
(a3) selecting an average particle size of the ceramic powder from the group consisting of: about 0.05 μm to about 1 μm; about 0.05 μm to about 0.8 μm; about 0.05 μm to about 0.6 μm; about 0.05 μm to about 0.4 μm; about 0.05 μm to about 0.2 μm; about 0.05 μm to about 0.1 μm; about 0.1 μm to about 1 μm; about 0.2 μm to about 1 μm; about 0.4 μm to about 1 μm; about 0.6 μm to about 1 μm; about 0.8 μm to about 1 μm; and about 0.1 μm to about 0.2 μm.

18. A method of forming a doped ceramic material according to claim 16, wherein the pre-firing step (a2) comprises the step of:
(a4) pre-firing the green body at a temperature selected from the group consisting of: about 700° C. to about 1100° C.; about 800° C. to about 1100° C.; about 9000° C. to about 1100° C.; about 1000° C. to about 1100° C.; about 700° C. to about 1000° C.; about 700° C. to about 900° C.; and about 700° C. to about 800° C.

19. A method of forming a doped ceramic material according to claim 16, wherein the pre-firing step (a2) comprises the step of:
(a5) pre-firing the green body for a time period selected from the group consisting of: about 1 hour to about 4 hours; about 2 hours to about 4 hours; about 3 hours to about 4 hours; about 1 hour to about 3 hours; and about 1 hour to about 2 hours.

20. A method of forming doped ceramic material according to claim 14, wherein the providing step (a) comprises the step of:
(a6) selecting the ceramic preform from compounds formed from at least two elements selected from the group consisting of: Group IIIA elements, Group IVA elements, Group IVB elements, Group VA elements and Group VIA elements of the periodic table of elements.

21. A method of forming a doped ceramic material according to claim 20, wherein the selecting step (a6) comprises the step of:
(a7) selecting the ceramic preform from the group consisting of SiC, Si₃N₄, Al₂O₃, AlN, ZrO₂, SiO₂ and composites thereof.

22. A method of forming a doped ceramic material according to claim 14, wherein the providing step (a) comprises the steps of:
(a8) shaping the ceramic preform.

23. A method of forming a doped ceramic material according to claim 21, wherein the selecting step (a7) comprises the step of:
(a7) selecting Al₂O₃ as the ceramic preform.

24. A method of forming a doped ceramic material according to claim 14, wherein the doping step (b) comprises the step of:
(b1) selecting a metal oxide as the dopant.

25. A method of forming a doped ceramic material according to claim 24, wherein the selecting step (b1) comprises the step of:
(b2) selecting a transition metal oxide as the metal oxide.

26. A method of forming a doped ceramic material according to claim 25, wherein the selecting step (b2) comprises the step of:
(b3) selecting chromium oxide (Cr₂O₃) as the transition metal oxide.

27. A method of forming a doped ceramic material according to claim 14, wherein the doping step (b) comprises the step of:
(b4) selecting the amount of dopant in the first layer from the group consisting of: about 0.1 mol % to about 5 mol %; about 0.3 mol % to about 5 mol %; about 0.6 mol % to about 5 mol %; about 1 mol % to about 5 mol %; about 2 mol % to about 5 mol %; about 3 mol % to about 5 mol %; about 4 mol % to about 5 mol %; about 0.1 mol % to about 4 mol %; about 0.1 mol % to about 3 mol %; about 0.1 mol % to about 2 mol %; about 0.1 mol % to about 1 mol %; about 0.1 mol % to about 0.6 mol %; and about 0.1 mol % to about 0.3 mol %.

28. A method of forming a doped ceramic material according to claim 14, wherein the doping step (b) comprises the step of:
(b5) selecting the amount of dopant in the second layer as about 0 mol %.

29. A method of forming a ceramic material according to claim 14, wherein the doping step (b) comprises the step of:
(b6) immersing the ceramic preform into a solution having a selected concentration of the dopant for a selected period of time to dope the first layer with the selected amount of dopant and to cause infiltration of the dopant into the ceramic preform.

30. A method of forming a ceramic material according to claim 29, wherein the immersing step (b6) comprises the step of:
(b7) immersing the ceramic preform into a solution of dopant for a period of time selected from the group consisting of: about 15 minutes to about 5 hours; about 30 minutes to about 5 hours; about 1 hour to about 5 hours; about 2 hours to about 5 hours; about 3 hours to about 5 hours; about 4 hours to about 5 hours; about 15 minutes to about 4 hours; about 15 minutes to about 3 hours; about 15 minutes to about 2 hours; about 15 minutes to about 1 hour; and about 15 minutes to about 30 minutes.

31. A method of forming a ceramic material according to claim 29, wherein the immersing step (b6) comprises the step of:
(b8) immersing the ceramic preform in a saturated solution of the dopant.

32. A method of forming a ceramic material according to claim 14, wherein said sintering step (c) comprises the step of:
(c1) sintering the ceramic preform at a temperature selected from the group consisting of: about 1200° C. to about 1600° C.; about 1200° C. to about 1500° C.; about 1200° C. to about 1400° C.; about 1200° C. to about 1300° C.; about 1300° C. to about 1600° C.; about 1400° C. to about 1600° C.; about 1500° C. to about 1600° C.; and about 1350° C. to about 1550° C.

33. A method of forming a ceramic material according to claim 14, wherein the sintering step (c) comprises the step of:
(c2) sintering the ceramic preform for a period of time selected from the group consisting of: about 1 hour to about 24 hours; about 5 hours to about 24 hours; about 10 hours to about 24 hours; about 15 hours to about 24 hours; about 20 hours to about 24 hours; about 1 hour to about 20 hours; about 1 hour to about 15 hours; about 1 hour to about 10 hours; and about 1 hour to about 5 hours.

34. A method of forming a ceramic material according to claim 14, wherein the sintering step (c) comprises the step of:
(c3) sintering the ceramic preform in a vacuum.

35. A method of forming a ceramic material according to claim 14, wherein the sintering step (c) comprises the step of:
(c4) sintering the ceramic preform in an environment of gases selected from the group consisting of: oxygen gas, nitrogen gas, argon gas, air and combinations thereof.

36. A chromium oxide (Cr₂O₃) doped alumina (Al₂O₃) material comprising:
(a) a first layer comprising Al₂O₃ and an amount of Cr₂O₃,
(b) a second layer comprising Al₂O₃, and
(c) a transitional layer connecting the first layer and the second layer, said transitional layer comprising Cr₂O₃ in an amount which decreases in a direction from the first layer to the second layer.

37. A method of forming Chromium Oxide (Cr₂O₃) doped alumina (Al₂O₃) material comprising the steps of:
(a) providing a high sinterability Al₂O₃ preform having a first layer, a second layer and a transitional layer connecting the first layer and the second layer;
(b) doping the first layer with an amount of Cr₂O₃ to thereby cause the amount of Cr₂O₃ in said transitional layer to decrease in a direction from the first layer to the second; and
(c) sintering the Al₂O₃ preform at a temperature for a period of time to form the Cr₂O₃ doped Al₂O₃ material.
